(19) United States
(12) Patent Application Publication
(10) Pub. No.: US 2026/0211146 A1
(43) Pub. Date: Jul. 23, 2026

(54) Portable Metal Detector Comprising A Helical Winding

(71) Applicant: COSTRUZIONI ELETTRONICHE INDUSTRIALI AUTOMATISMI S.P.A. C.E.I.A. S.P.A., Arezzo (IT)

(72) Inventor: Giovanni MANNESCHI, AREZZO (IT)

(73) Assignee: COSTRUZIONI ELETTRONICHE INDUSTRIALI AUTOMATISMI S.P.A. C.E.I.A. S.P.A., Arezzo (IT)

(21) Appl. No.: 19/137,849

(22) PCT Filed: Dec. 12, 2023
(86) PCT No.: PCT/EP2023/085340

§ 371 Date: Jun. 11, 2025

(30) Foreign Application Priority Data
Dec. 12, 2022 (FR) FR2213172

(51) Int. Cl. G01V 3/10; G01V 3/165

(52) U.S. Cl. CPC G01V 3/108; G01V 3/165

(57) ABSTRACT

The invention relates to a portable metal detector (I) comprising:—a cylindrical support (7) made of dielectric material which has a general direction of extension that defines an axis (X) of the metal detector (I), the cylindrical support (7) having, between a first end (9) and a second end (10) of the cylindrical support (7), a diameter (D) in a plane normal to the axis (X) of the detector; and an inductive sensor (5) comprising a winding (8) helically wound around the cylindrical support (7) from the first end (9) to the second end (10) of the cylindrical support (7) so as to form a helix, a pitch (P) of the helix being strictly greater than the diameter (D) of the cylindrical support (7).

### TECHNICAL FIELD

The present application relates to the general technical field of portable metal detectors, in particular for the detection of metals, for example when accessing a departure lounge in an airport or any other similar place with controlled access, but also for personal (leisure) and commercial use.

### BACKGROUND

A portable metal detector generally comprises a handle for an operator to grip the detector, a body including measuring means and processing means.

The measuring means may for example comprise an inductive sensor for measuring the inductance variation caused by the metals to be detected. The inductive sensor may comprise either a single winding forming a transmitter and a receiver or separate transmitter winding and receiver winding. The transmitter winding generates an electromagnetic field that can effectively penetrate non-metal materials, such as soil, water, clothing, etc. The presence of a metal body in the vicinity of the windings disturbs the magnetic field generated by the winding. This disturbance is detected by the processing means which send an alert command to an alarm of the detector.

The windings of the detection probe of portable detectors usually comprise planar, rectangular or circular coils so as to optimize the surface/perimeter ratio and therefore show sufficient sensitivity at several centimeters of distance from the windings, or be transversely coiled around a support, which allows having a more compact detection probe but with a strong loss of sensitivity at short distances.

### SUMMARY

One aim of the present application is to overcome the aforementioned drawbacks by proposing a portable metal detector that is compact while having a suitable sensitivity, at least equivalent to that of standard portable detectors.

To this end, a portable metal detector in accordance with the appended claims is proposed.

The portable metal detector may in particular comprise:
a cylindrical support made of dielectric material having a general direction of extension defining an axis of the metal detector, the cylindrical support having, between a first end and a second end of the cylindrical support, a diameter in a plane normal to the axis of the detector; and
an inductive sensor comprising:
   a transmitter winding helically coiled around the cylindrical support from the first end to the second end of the cylindrical support so as to form a transmitter helix; and
   a receiver winding helically coiled around the cylindrical support between the first end and the second end of the cylindrical support so as to form a receiver helix.

In addition, a pitch of the transmitter helix and a pitch of the receiver helix are strictly greater than the diameter of the cylindrical support.

Some preferred but non-limiting characteristics of the portable metal detector described above are the following, taken individually or in combination:
the transmitter helix and the receiver helix comprise at least one turn, preferably at least two turns;
the pitch of the transmitter helix and the pitch of the receiver helix are identical;
the transmitter helix and the receiver helix are angularly shifted by 90° between the first end and the second end of the cylindrical support;
the transmitter helix and the receiver helix rotate in opposite directions about the axis of the metal detector between the first end and the second end such that the winding and the receiver winding intersect;
the transmitter helix and the receiver helix rotate in the same direction about the axis of the metal detector between the first and second ends;
the portable metal detector further comprises an additional transmitter winding helically coiled around the cylindrical support between the first end and the second end of the cylindrical support so as to form an additional transmitter helix, a pitch of the additional transmitter helix being strictly greater than the diameter of the cylindrical support;
the pitch of the additional transmitter helix is equal to the pitch of the transmitter helix and in which the transmitter helix and the additional transmitter helix rotate in opposite directions about the axis of the metal detector between the first end and the second end such that the transmitter winding and the additional transmitter winding intersect;
the transmitter helix and the additional transmitter helix intersect at the first end at the level of an intersection point;
the portable metal detector further comprises an additional receiver winding helically coiled around the cylindrical support between the first end and the second end of the cylindrical support so as to form an additional receiver helix, a pitch of the additional receiver helix being strictly greater than the diameter of the cylindrical support;
the pitch of the additional receiver helix is. equal to the pitch of the receiver helix, and the receiver helix and the additional receiver helix rotate in opposite directions about the axis of the metal detector between the first end and the second end such that the receiver winding and the additional receiver winding intersect;
the receiver helix and the additional receiver helix intersect at the first end at the level of an additional intersection point;
the intersection point and the additional intersection point are angularly shifted by 90°;
the portable metal detector further comprises a handle connected to the cylindrical support; and/or
the transmitter winding and the receiver winding are coiled against the cylindrical support so as to be in contact with the cylindrical support.

### DESCRIPTION OF THE FIGURES

Other characteristics, aims and advantages will emerge from the following description, which is purely illustrative and non-limiting, and which must be read in relation to the appended drawings in which:

FIG. 1a is a schematic front view of one exemplary body of a metal detector in accordance with a first embodiment;

FIG. 1b is a bottom view of the body of FIG. 1a;

FIG. 2a is a schematic front view of a first exemplary body of a metal detector in accordance with a second embodiment;

FIG. 2b is a bottom view of the body of FIG. 2a;

FIG. 3a is a schematic front view of a second exemplary body of a metal detector in accordance with a third embodiment;

FIG. 3b is a bottom view of the body of FIG. 3a;

FIG. 4a is a schematic front view of a second exemplary body of a metal detector in accordance with a fourth embodiment;

FIG. 4b is a bottom view of the body of FIG. 4a;

FIG. 5 schematically represents a control system that can be used in a metal detector in accordance with one embodiment;

FIG. 6a schematically represents one exemplary processing means of a metal detector in accordance with a first embodiment;

FIG. 6b schematically represents one exemplary processing means of a metal detector in accordance with a second embodiment;

FIG. 6c schematically represents one exemplary processing means of a metal detector in accordance with a third embodiment;

FIG. 7 illustrates one exemplary metal object detector in accordance with one embodiment;

FIG. 8 illustrates the magnetic field generated by one exemplary planar winding; and

FIG. 9 illustrates the magnetic field generated by one exemplary a winding forming a helix in accordance with one embodiment.

In all the figures, similar elements bear identical references.

### DETAILED DESCRIPTION

A portable metal detector 1 comprises:
a handle 2 for gripping the detector 1 by an operator;
a body 4 including an inductive sensor 5; and
processing means 6 connected to the inductive sensor 5 and configured to detect a disturbance in the magnetic field generated by the inductive sensor 5 and to deduce therefrom the presence of a metal body.

The inductive sensor 5 comprises a cylindrical support 7 made of dielectric material and one or more windings forming a transmitter 8 and/or a receiver 11 coiled around the cylindrical support 7.

The cylindrical support 7 has a general direction of extension defining an axis X of the metal detector 1. This axis X of the detector 1 is substantially parallel to the generatrix of the cylindrical support 7. The cylindrical support 7 is preferably symmetrical and may in particular be cylindrical of revolution (tubular) or polygonal (and preferably comprise at least five sides, for example between six and twelve sides), the axis X of the detector 1 then corresponding to an axis of symmetry X of the cylindrical support 7.

In the present application, the axial direction corresponds to the direction of the axis X of the detector 1 and a radial direction is a direction perpendicular to this axis X and passing therethrough. Moreover, the circumferential (or lateral) direction corresponds to a direction perpendicular to the axis X and not passing therethrough.

The cylindrical support 7 has a first end 9 which is connected to the handle 2 and a second end 10, which is opposite to the first end 9 along the axis X and which extends in the vicinity of a free end of the detector 1. An axial length L of the cylindrical support 7 corresponds to the distance, along the axis X, between the first and second ends 10. Moreover, the cylindrical support 7 has a diameter D, in a plane normal to the axis X, between the first and second ends 10. By diameter D, it is meant here the greatest length along the radial direction which separates two points of the object. In the case of a polygonal cylindrical support 7, the diameter D corresponds for example to the diagonal of the polygon. The diameter D and the axial length L of the cylindrical support 7 are chosen according to the application of the metal detector 1. For example, the diameter D of the cylindrical support 7 is at least equal to 15 mm, for example between 20 mm and 70 mm. The axial length L of the cylindrical support 7 is at least twice as large as its diameter D, for example at least equal to 50 mm, preferably between 100 mm and 500 mm, typically of the order of 250 mm.

The cylindrical support 7 can be made of any suitable dielectric material that has no effect on the operation of the inductive sensor 5, for example made of plastic material such as polyvinyl chloride PVC, acrylonitrile butadiene styrene ABS, polycarbonate PC or a mixture thereof. It is also housed in a casing 3 which is fixed to the handle 2 of the detector 1.

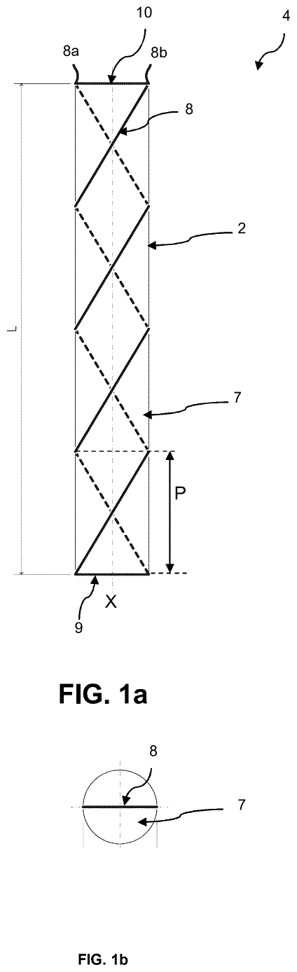

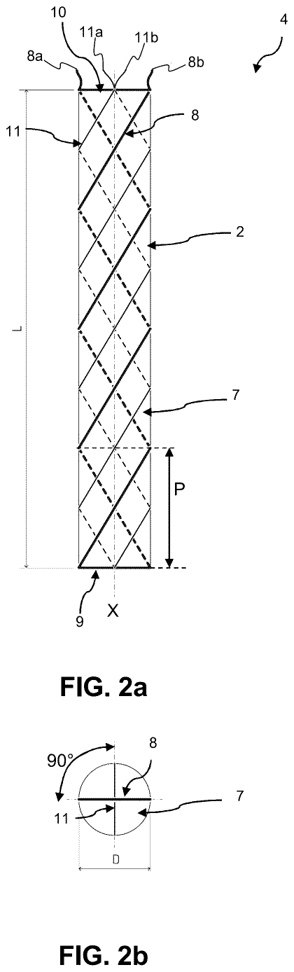

The transmitter element 8 is powered by an alternating electric current and is configured to generate a magnetic field. The receiver element is configured to receive the magnetic field and detect, thanks to the processing means 6, disturbances in the magnetic field due to the presence of a metal body, for example the attenuation of the amplitude of the magnetic field, or even the phase change of the signal, due for example to the eddy currents generated on the metal body. In a first embodiment (illustrated as an example in FIGS. 1a and 1b), the same winding 8 plays the role of the transmitter element and of the receiver element. This same winding is therefore configured to alternately generate the magnetic field and detect its disturbances. In a second embodiment (illustrated by way of example in FIGS. 2a to 4b), the inductive sensor 5 comprises a first winding 8, or transmitter winding, configured to form a transmitter element and a second winding 11, or receiver winding, configured to form a receiver element that is distinct from the transmitter winding 8. Each winding 8, 11 is formed from a metal wire having two ends 8a, 8b and 11a, 11b.

Each winding 8, 11 is preferably coiled against the cylindrical support 7 so as to be in contact with the cylindrical support 7 over a majority of its length, preferably over its entire length, except at the level of overlaps between the metal wires of the windings.

A portable detector 1 is therefore structurally different from a fixed metal detector. Indeed, the portable metal detector 1 comprises an inductive sensor 5 equipped with a single antenna that simultaneously includes at least one transmitter element and at least one receiver element, which are coiled on a single support 7. Conversely, a fixed metal detector comprises two distinct panels, which can be connected by a crosspiece and which together delimit a channel, each panel including an antenna forming either a transmitter or a receiver. The transmitter and receiver elements are therefore not housed in the same panel but in distinct panels and therefore cannot, a fortiori, be coiled on the same support.

Regardless of the embodiment, the winding 8 forming the transmitter element is helically coiled around the cylindrical support 7, from the first end 9 to the second end 10 of the cylindrical support 7, so as to form a first helix, or “transmitter helix”.

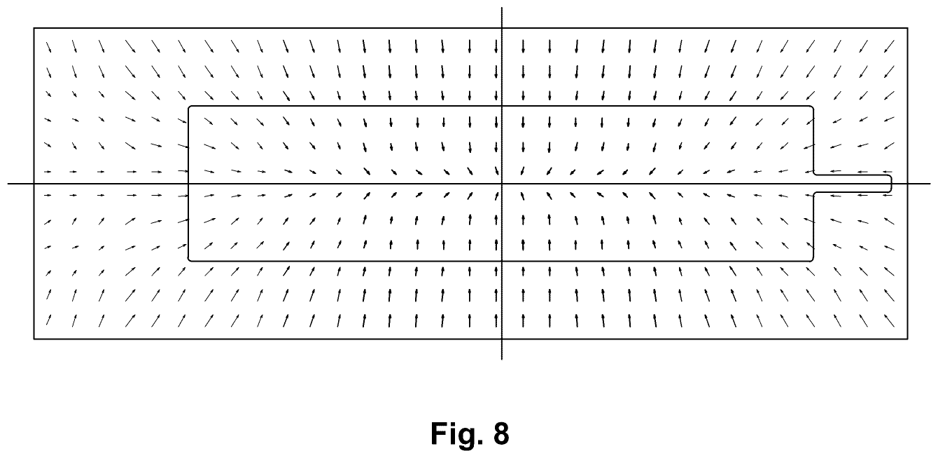

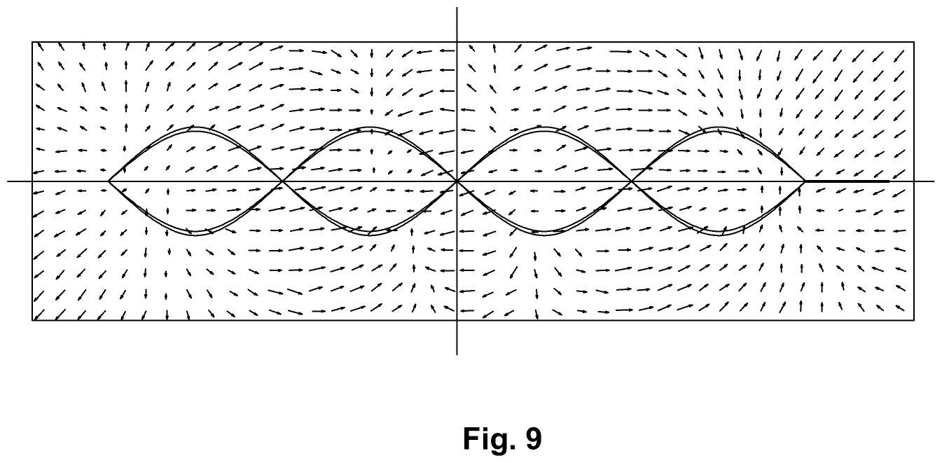

In order to improve the sensitivity of the detector 1, a pitch P of the transmitter helix is strictly greater than the diameter D of the cylindrical support 7. The loops of the transmitter helix are therefore not contiguous but separated by an axial distance at least equal to the diameter D of the cylindrical support 7, so that the winding 8 forming the transmitter element extends substantially axially along the cylindrical support 7, and not only orthogonally thereto. The magnetic field obtained is therefore more uniform. Consequently, the winding 8 forming the receiver element (whether it is the same winding (first embodiment) or the receiver winding 11 (second embodiment) is likely to interact with the metal body, whatever its position or shape. This is particularly relevant in the case where the metal body is elongated. Indeed, the interaction between a metal body and the metal detector 1 depends on the number of flux lines captured by the metal body. However, in the case of an elongated metal body, such as a knife, few disturbed flux lines are disturbed by the metal body if it is perpendicular to the flux lines. Thus, when the turns are contiguous (small pitch of the helix compared to the diameter D of the cylindrical support 7) and when the metal body is perpendicular to the field lines, the disturbance in the magnetic field is negligible. On the other hand, when the winding forming the transmitter element 8, 12 is helically coiled around of the cylindrical support 7 following a pitch P greater than the diameter D of the cylindrical body 4, the turns of the transmitter helix are necessarily distant so that the magnetic field continuously changes direction over the entire axial length L of the cylindrical support 7: the metal body will therefore necessarily disturb field lines generated by the coil forming the transmitter element 8, whatever its position relative to the metal detector 1. This in particular emerges from FIGS. 8 and 9, which illustrate the magnetic field obtained by a planar winding (FIG. 8) and a helical winding in accordance with one embodiment (FIG. 9). It emerges from the comparison of these two diagrams that the winding forming a helix (FIG. 9) generates a magnetic field whose direction changes between the ends 9, 10 of the cylindrical support 7: the variation of the coupling between the magnetic field and a metal in particular an elongated object, is therefore minimized, in comparison with the magnetic field substantially generated by the planar coil (FIG. 8), which remains substantially perpendicular to the planar winding over the entire length of the cylindrical support. The interaction between the metal body and the magnetic field obtained by coiling the winding(s) 8, 11 in the form of helices is therefore independent of the orientation and shape of the metal body.

In addition, the intensity of the magnetic field generated by a winding rotating on a solid shape (here, helically on the cylindrical support 7) is much greater than the intensity of the magnetic field generated by a flat coil in a plane and having the same curvilinear length, in a smaller overall dimension.

In order to generate a uniform magnetic field, each helix is preferably centered on the axis X of the detector 1, such that its center of curvature lies on the axis X of the detector 1. In addition, it has a substantially regular pitch P between the first and second ends 10 of the cylindrical support 7.

Each helix comprises at least one turn, preferably at least two turns. The transmitter winding 8 consequently performs a turn about the axis X by at least 360° between the first and second ends 10 of the support, preferably by at least 720°, thereby minimizing the influence and the interference with the equipment placed in the vicinity of the metal detector 1. For example, in FIGS. 1a, 2a, 3a, and 4a, the helices perform exactly two turns about the axis X.

In the first embodiment (FIGS. 1 and 1b), the winding forms both the transmitter element and the receiver element. The inductive sensor 5 therefore comprises a single transmitter winding.

In the second embodiment (FIGS. 2a to 4b), the inductive sensor 5 comprises the first winding 8 (transmitter winding) forming the transmitter element and the second winding 11 (receiver winding) forming the receiver element, which is distinct from the transmitter winding 8. The receiver winding 11 is then helically coiled around the cylindrical support 7 between the first end 9 and the second end 10 of the cylindrical support 7 so as to form a second helix, or “receiver helix”. In addition, the pitch of the receiver helix is strictly greater than the diameter D of the cylindrical support 7.

Preferably, the pitch P of the transmitter helix and the pitch of the receiver helix are identical and the two helices are centered on the axis X of the detector 1.

The receiver winding 11 may in particular be coiled from the first to the second end 10 of the cylindrical support 7. The transmitter winding 8 and the receiver winding 11 both extend along the cylindrical support 7, over a distance equal to the axial length L of the cylindrical support 7.

The transmitter winding 8 and the receiver winding 11 may be coiled around the cylindrical support 7 so that the receiver helix and the transmitter helix are angularly shifted by 90° between the first end 9 and the second end 10 of the cylindrical support 7. In other words, at the level of the first end 9 of the cylindrical support 7, the plane passing the starting points 8a, 8b of the transmitter helix (terminals of the transmitter winding 8, at the intersection of the helices) form an angle of 90° with the plane passing through the axis X and the starting points 11a, 11b of the end of the receiver helix (terminals of the receiver winding 11, at the intersection of the helices). This angular deviation between the transmitter and receiver windings 8, 11 makes it possible to reduce the mutual inductance between the transmitter winding 8 and the receiver winding 11 so that the voltage induced by the transmitter winding 8 on the receiver winding 11 is zero, which makes it possible to amplify the receiver signal without saturating the amplification step of the processing means 6. The metal detector 1 can thus detect more distant metal bodies. Moreover, the intensity of the magnetic field generated is greater for the same overall dimension.

The transmitter helix and the receiver helix can rotate in the same direction about the axis X of the detector 1 between the first end 9 and the second end 10. When the pitch P of the helices is identical, the angular deviation between the transmitter helix and the receiver helix is therefore maintained over the entire axial length L of the cylindrical support 7 so that the transmitter winding 8 and the receiver winding 11 follow each other parallel from one end to the other of the cylindrical support 7. In this example, the transmitter helix and the receiver helix are therefore both dextral or both sinistral.

As one variant, the transmitter helix and the receiver helix can rotate in opposite directions about the axis X of the detector 1 between the first end 9 and the second end 10 so that the transmitter winding 8 and the receiver winding 11 intersect. For example, the transmitter helix is dextral and the receiver helix is sinistral (or vice versa). This embodiment makes it possible to minimize the coupling and the mutual inductance between the transmitter 8 and receiver 11 windings, insofar as the transmitter and receiver windings 8, 11 do not follow each other in parallel along the cylindrical support 7 but intersect perpendicularly.

In one variant embodiment, the inductive sensor 5 further comprises an additional transmitter winding 12 and/or an additional receiver winding 13, which are distinct from the transmitter winding 8 and from the receiver winding 11, respectively, and which are helically coiled around the cylindrical support 7 between the first end 9 and the second end 10 of the cylindrical support 7 so as to form a third helix, or “additional transmitter helix,” and/or a fourth helix, or “additional receiver helix”.

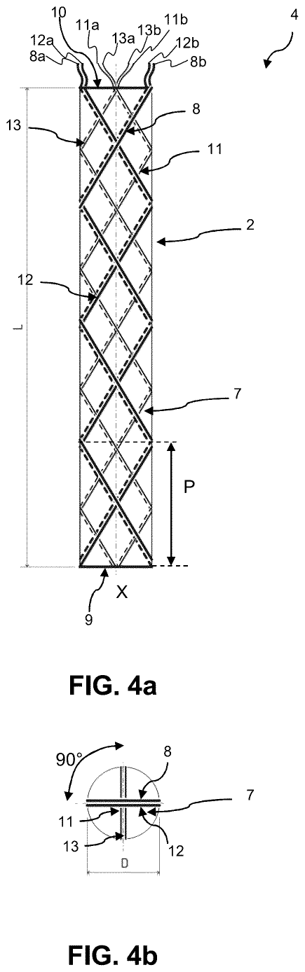

For example, the inductive sensor 5 further comprises an additional transmitter winding 12 and an additional receiver winding 13 (variant illustrated as an example in FIGS. 4a and 4b) which are helically coiled around the cylindrical support 7 between the first end 9 and the second end 10 of the cylindrical support 7 so as to form an additional transmitter helix and an additional receiver helix.

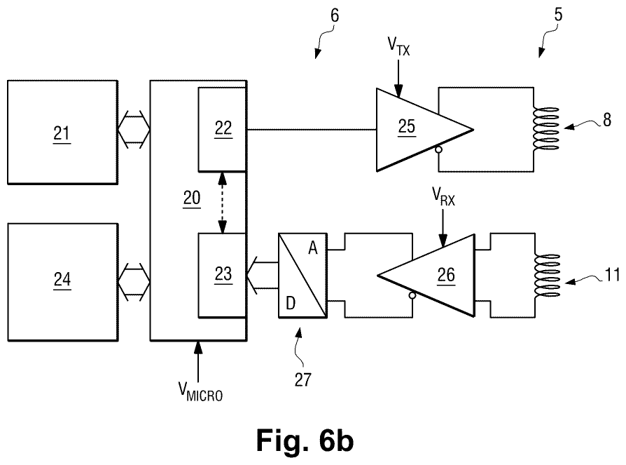

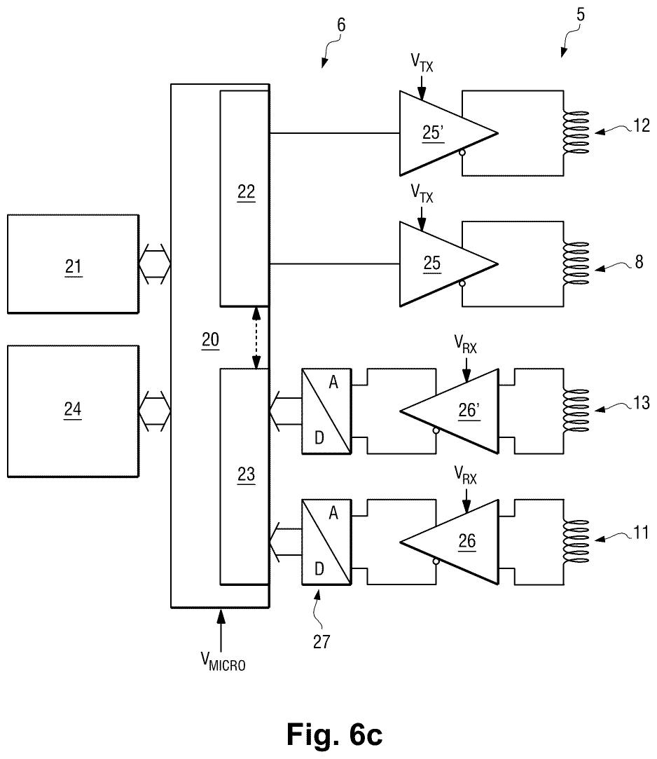

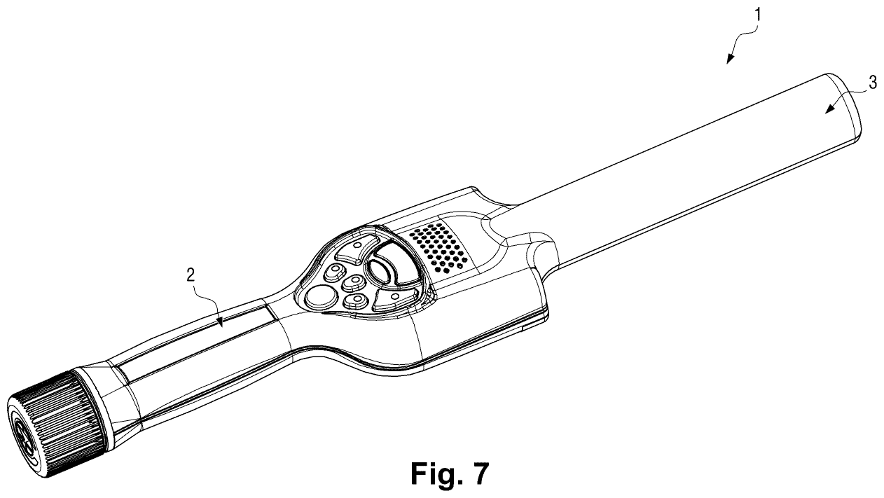

Each winding 12, 13 is formed of a metal wire having two ends 12a, 12b and 13a, 13b. This variant embodiment makes it possible to further improve the uniformity of the response of metal objects, whatever their shape. On the other hand, the processing means 6 are more complex, as is apparent for example from FIG. 6c.

The pitch of the additional transmitter helix and the pitch of the additional receiver helix are strictly greater than the diameter D of the cylindrical support 7.

The additional transmitter winding 12 is powered by an alternating electric current and is configured to generate a magnetic field. If necessary, the transmitter winding 8 and the additional transmitter winding 12 may be powered by current sources having different frequencies or by current sources having the same frequency but which are phase-shifted, typically shifted by 90°.

The additional receiver winding 13 is configured to receive the magnetic field generated by the transmitter winding(s) 8, 12 and to detect, thanks to the processing means 6, disturbances in the magnetic field due to the presence of a metal body.

Preferably, the pitch P of the transmitter helix and the pitch of the additional transmitter helix are identical. The additional transmitter helix is furthermore also centered on the axis X of the detector 1. Likewise, the pitch P of the receiver helix and the pitch of the additional receiver helix are identical. The additional receiver helix is furthermore also centered on the axis X of the detector 1.

The additional transmitter and receiver windings 12, 13 may in particular be coiled from the first to the second end 10 of the cylindrical support 7. The windings 8, 11, 12, 13 then all extend along the cylindrical support 7, over a distance equal to the axial length L of the cylindrical support 7.

The transmitter winding 8 and the additional transmitter winding 12 may be coiled around the cylindrical support 7 so that the transmitter helix and the additional transmitter helix share the same starting point at the first end 9 and the same arrival point at the second end 10 of the cylindrical support 7. In addition, the transmitter helix and the additional transmitter helix preferably rotate in opposite directions about the axis X of the detector 1 between the first end 9 and the second end 10 so that the transmitter winding 8 and the additional transmitter winding 12 intersect, preferably with an identical pitch. For example, the transmitter helix is dextral and the additional transmitter helix is sinistral (or vice versa).

When the inductive sensor 5 comprises two transmitter windings 8, 12, each transmitter winding 8, 12 generates a magnetic field. Given the configuration of the transmitter windings (opposite direction of rotation and positioning at the level of the ends 9 and 10), these magnetic fields are substantially perpendicular to each other. Consequently, when an elongated metal object is placed in the vicinity of the detector 1, there is necessarily a high coupling between the metal object and at least one of the magnetic fields.

Moreover, when the inductive sensor 5 comprises two receiver windings 11, 13, the receiver windings 11, 13 are coiled around the cylindrical support 7 so that the receiver helix and the additional receiver helix preferably rotate in opposite directions about the axis X of the detector 1 between the first end 9 and the second end 10 so that the receiver winding 11 and the additional receiver winding 13 intersect, preferably with an identical pitch. For example, the receiver helix is dextral and the additional receiver helix is sinistral (or vice versa). The use of two receiver windings 11, 13 makes it possible to reduce the variation in the signal intensity when the metal object being detected is elongated.

In addition, when the inductive sensor 5 comprises two receiver windings 11, 13 and two transmitter windings 8, 12, the receiver helix and the additional receiver helix preferably share the same starting point at the first end 9 and the same arrival point at the second end 10 of the cylindrical support 7, the starting point of the transmitter helices 8, 12 being angularly shifted by 90° from the starting point of the receiver helices 11, 13. In other words, at the level of the first end 9 of the cylindrical support 7, the plane passing the starting points of the transmitter helices forms an angle of 90° with the plane passing through the axis X and the starting points of the end of the receiver helices (see FIG. 4b).

It should be noted that in FIGS. 4a and 4b, the transmitter helix and the additional transmitter helix on the one hand and the receiver helix and the additional receiver helix on the other hand are represented in a slightly shifted manner for the sake of simplification in order to be able to view them.

Optionally, one or more helical grooves may be formed on the surface of the cylindrical support 7 in order to block the transmitter winding(s) 8, 12 and the receiver winding(s) 11, 13 relative to the cylindrical support 7. The grooves therefore extend circumferentially around the cylindrical support 7 and are preferably through-grooves. All or part of the windings (transmitter(s) 8, 12, receiver(s) 11, 13) are then housed in a corresponding groove, which makes it possible to reduce the relative movements of the windings 8, 12, 11, 13 likely to disturb the detection.

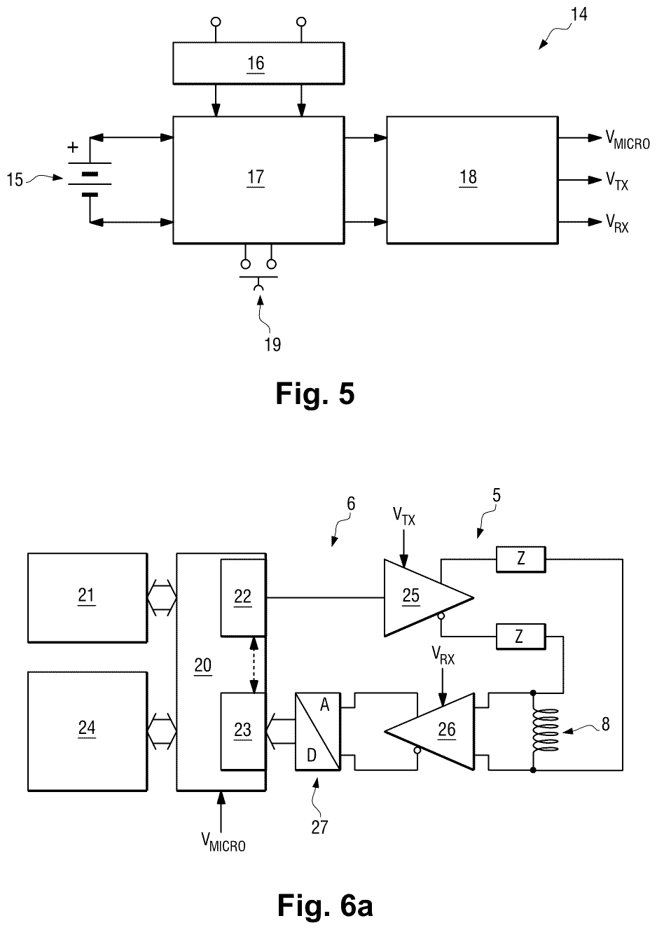

Regardless of the embodiment, the metal detector 1 may include a supply system 14 comprising a self-contained power supply source 15, such as a cell or a battery that may be rechargeable, configured to power the transmitter winding(s) 8, 12 and the processing means 6. FIG. 5 represents for example a supply system 14 comprising a rechargeable battery 15, a battery charger 16, a controller 17, a power supply regulator 18 and a switch 19. The voltages V_{MICRO}, V_{TX} and V_{RX} at the output of the power supply regulator 18 are transmitted to the processing means 6 of the inductive sensor 5 (FIGS. 6a to 6c).

The processing means 6 may comprise a microprocessor 20 such as one or more electronic cards, a memory and where appropriate an alarm 21 (which may be an audible and/or visual alarm). The processing means 6 are connected to the inductive sensor 5 and are configured to receive and process signals generated by the winding(s) forming a receiver 11, 13 and, if necessary, send instructions for generating an alarm to the alarm 21 of the metal detector 1.

By way of non-limiting example, the processing means 6 comprise:
a microprocessor 20 comprising a digital frequency synthesizer DDS (for Direct Digital Synthesis) 22 and a digital mixer 23 connected to the DDS. The DDS is configured to generate a control signal having a determined frequency which is transmitted to the transmitter winding 8. The digital mixer 23 is configured to receive a signal from the receiver winding 11, and to deduce, from the frequency of the control signal, a disturbance in the magnetic field;
an alarm 21 connected to the microprocessor 20 and configured to receive instructions from the microprocessor 20;
control means 24, such as buttons, configured to be actuated by an operator and allow the operator to control a sensitivity of the inductive sensor 5 and/or an amplitude (sound level/light intensity/color) of the alarm 21;
a first amplifier 25 configured to amplify the control signal generated by the DDS and transmit the amplified signal to the transmitter winding 8;
a second amplifier 26 configured to amplify a signal received by the receiver winding 11, and transmit the amplified signal to the digital mixer 23 via a digital-to-analog converter 27.

The processing means 6 may be housed in all or part of the casing 3 of the body 4 and/or in the handle 2 of the metal detector 1.

FIG. 6a illustrates one embodiment in which the inductive sensor 5 comprises only a single winding forming a transmitter and a receiver, the first amplifier 25 preferably drives the winding via impedances Z. The processing means 6 illustrated in FIG. 6a may therefore be implemented in a detector comprising an inductive sensor 5 as described with reference to FIGS. 1a and 1b.

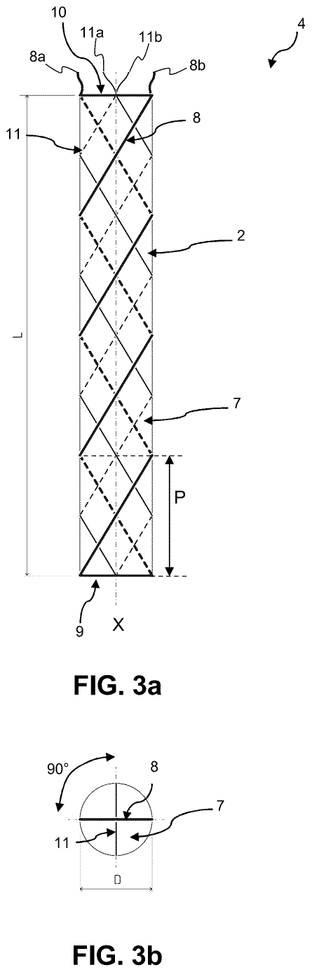

FIG. 6b illustrates one embodiment in which the inductive sensor 5 comprises a transmitter winding 8 and a receiver winding 11. The processing means 6 illustrated in FIG. 6b may therefore be implemented in a detector comprising an inductive sensor 5 as described with reference to FIGS. 2a and 2b or 3a and 3b.

FIG. 6c illustrates one embodiment in which the inductive sensor comprises two transmitter windings 8, 12 and two receiver windings 11, 13. In this case, the processing means 6 may comprise a first additional amplifier 25′ connected to the DDS 22 and a second additional amplifier 26′ connected to the digital mixer 23. The processing means 6 illustrated in FIG. 6c may therefore be implemented in a detector comprising an inductive sensor 5 as described with reference to FIGS. 4a and 4b.

1. A portable metal detector comprising:
a cylindrical support made of dielectric material having a general direction of extension defining an axis of the metal detector, the cylindrical support having, between a first end and a second end of the cylindrical support, a diameter in a plane normal to the axis of the detector; and
an inductive sensor comprising:
a transmitter winding helically coiled around the cylindrical support from the first end to the second end of the cylindrical support so as to form a transmitter helix; and
a receiver winding helically coiled around the cylindrical support between the first end and the second end of the cylindrical support so as to form a receiver helix;
a pitch of the transmitter helix and a pitch of the receiver helix being strictly greater than the diameter of the cylindrical support.

2. The metal detector according to claim 1, wherein the transmitter helix and the receiver helix comprise at least one turn.

3. The metal detector according to claim 1, wherein the pitch of the transmitter helix and the pitch of the receiver helix are identical.

4. The metal detector according to claim 1, the transmitter helix and the receiver helix are angularly shifted by 90° between the first end and the second end of the cylindrical support.

5. The metal detector according to claim 1, the transmitter helix and the receiver helix rotate in opposite directions about the axis of the metal detector between the first end and the second end such that the winding and the receiver winding intersect.

6. The metal detector according to claim 1, the transmitter helix and the receiver helix rotate in the same direction about the axis of the metal detector between the first and second ends.

7. The metal detector according to claim 1, further comprising an additional transmitter winding helically coiled around the cylindrical support between the first end and the second end of the cylindrical support so as to form an additional transmitter helix, a pitch of the additional transmitter helix being strictly greater than the diameter of the cylindrical support.

8. The metal detector according to claim 7, wherein the pitch of the additional transmitter helix is equal to the pitch of the transmitter helix and wherein the transmitter helix and the additional transmitter helix rotate in opposite directions about the axis of the metal detector between the first end and the second end such that the transmitter winding and the additional transmitter winding intersect.

9. The metal detector according to claim 7, wherein the transmitter helix and the additional transmitter helix intersect at the first end at an intersection point.

10. The metal detector according to claim 1, further comprising an additional receiver winding helically coiled around the cylindrical support between the first end and the second end of the cylindrical support so as to form an additional receiver helix, a pitch of the additional receiver helix being strictly greater than the diameter of the cylindrical support.

11. The metal detector according to claim 10, wherein the pitch of the additional receiver helix is equal to the pitch of the receiver helix, and the receiver helix and the additional receiver helix rotate in opposite directions about the axis of the metal detector between the first end and the second end such that the receiver winding and the additional receiver winding intersect.

12. The metal detector according to claim 10, wherein the receiver helix and the additional receiver helix intersect at the first end at an additional intersection point.

13. The metal detector according to claim 1, further comprising an additional receiver winding helically coiled around the cylindrical support between the first end and the second end of the cylindrical support so as to form an additional receiver helix, a pitch of the additional receiver helix being strictly greater than the diameter of the cylindrical support,
wherein the pitch of the additional receiver helix is equal to the pitch of the receiver helix, and the receiver helix and the additional receiver helix rotate in opposite directions about the axis of the metal detector between the first end and the second end such that the receiver winding and the additional receiver winding intersect,
wherein the transmitter helix and the additional transmitter helix intersect at the first end at an intersection point,
wherein the receiver helix and the additional receiver helix intersect at the first end at an additional intersection point, and
wherein the intersection point and the additional intersection point are angularly shifted by 90°.

14. The metal detector according to claim 1, further comprising a handle connected to the cylindrical support.

15. The metal detector according to claim 1, wherein the transmitter winding and the receiver winding are coiled against the cylindrical support so as to be in contact with the cylindrical support.

16. The metal detector according to claim 1, wherein the transmitter helix and the receiver helix comprise at least two turns.
